(19) United States
(12) Patent Application Publication
(10) Pub. No.: US 2012/0274241 A1
(43) Pub. Date: Nov. 1, 2012

(54) SOLAR CONTROLLER AND SOLAR ROAD LAMP HAVING SAME

(75) Inventors: YAU-LEUNG CHAN, Tu-Cheng (TW); CHENG-HUANG CHEN, Tu-Cheng (TW)

(73) Assignee: HON HAI PRECISION INDUSTRY CO., LTD., Tu-Cheng (TW)

(21) Appl. No.: 13/160,500

(22) Filed: Jun. 14, 2011

(30) Foreign Application Priority Data
Apr. 28, 2011 (TW) 100207575

(51) Int. Cl. H05B 37/02; G04C 11/02

(52) U.S. Cl. 315/360; 368/47

(57) ABSTRACT

A solar controller includes a microcontroller and a radio controlled clock receiving a time signal from a radio station and being synchronized to the time signal. The microcontroller is configured to store time-related data provided by the radio controlled clock.

### BACKGROUND

1. Technical Field

The present disclosure relates to solar controller and solar road lamp having the solar controller.

2. Description of Related Art

Many solar road lamps rely on Real Time Controller (RTC) modules to automatically switch on and off at predetermined times. However, over time the RTC module errors may become apparent or grow larger, such as the RTC module not keeping good time anymore. For example, an RTC module will lose or gain as much as 1.7 seconds per day, which is about 10.34 minutes per year. Thus the lamps in the same area or on the same street may not turn on and off at the same time depending on the age of the RTC module and the amount of gain or loss in time keeping.

What is needed, therefore, is an accurate solar controller and a solar road lamp including the controller.

### BRIEF DESCRIPTION OF THE DRAWINGS

Many aspects of the present solar controller and solar road lamp can be better understood with reference to the following drawings. The components in the drawings are not necessarily drawn to scale, the emphasis instead being placed upon clearly illustrating the principles of the present solar controller and solar road lamp including the solar controller. Moreover, in the drawings, like reference numerals designate corresponding parts throughout the views.

FIG. 1 shows a solar road lamp according to an embodiment of this disclosure.

FIG. 2 shows a solar controller installed in the solar road lamp of FIG. 1 and the relationship between the solar controller and the light source.

### DETAILED DESCRIPTION

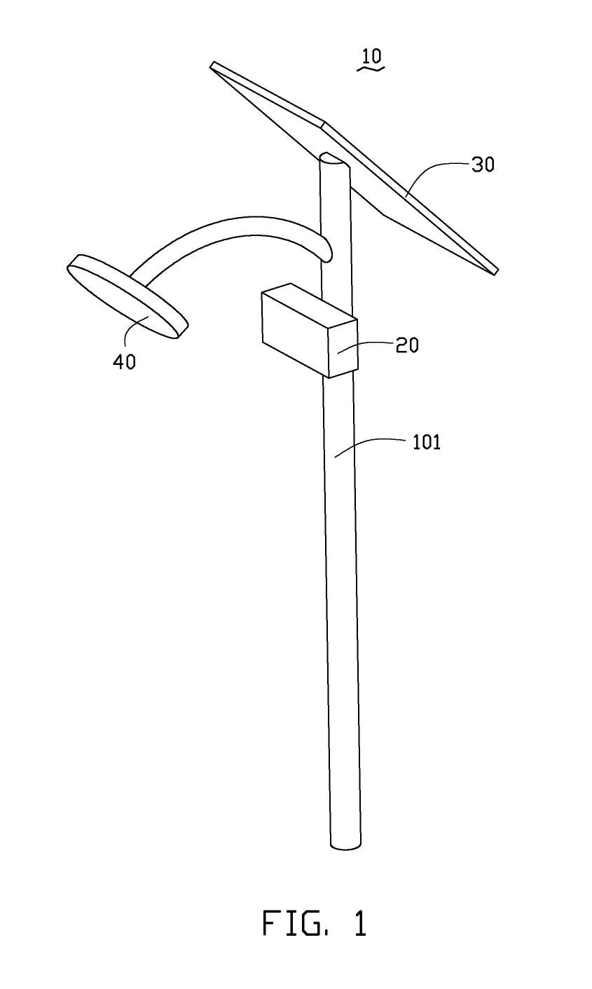

Referring to FIG. 1, a solar road lamp 10 includes a solar controller 20, a solar panel 30, and a light emitting diode (LED) light source 40. The solar panel 30 may be located on the top of the light source 40. The solar controller 20 is located inside or outside a trunk 101 of the solar road lamp 10. The solar panel 30 is configured to convert sunlight into electrical energy during the sunny day. The electrical energy is mainly applied to the LED light source 40 at night. In addition to using LED light source, other light sources, such as cold cathode fluorescent tubes (CCFL), may also be used.

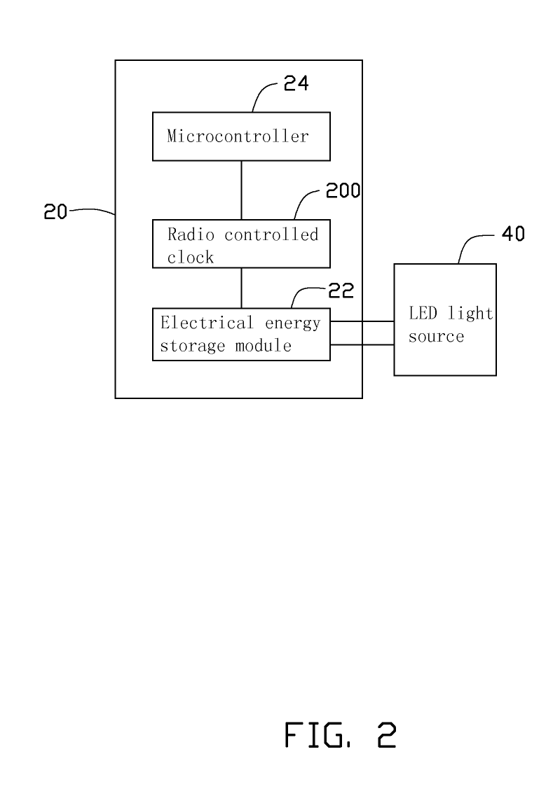

Please referring to FIG. 2, the solar controller 20 includes an electrical energy storage module 22, a microcontroller 24, and a radio controlled clock 200. The storage module 22 is used to store the electrical energy produced by the solar panel 30 and supply the electricity energy to the radio controlled clock 200. The microcontroller 24 is configured to control times of operation of the solar road lamp 10 according to stored time-related data.

The radio controlled clock 200 is configured to obtain local time and to transfer the time to the microcontroller 24, and may also be configured to display the time. The radio controlled clock 200 can be the kind, for example, that has high sensitivity for receiving time signals from an atomic transmitters of a radio station, by which it determines local time and thus synchronizes to the local time. A known error rate of such radio controlled clocks is about one second per three hundred thousand years. In detail, the radio controlled clock 200 includes a radio receiver system to receive the time signals. The radio controlled clock 200 may be powered by the storage module 22 or a dry battery.

When the radio controlled clock 200 reaches the predetermined time, such as 18:30, the microcontroller 24 will control the storage module 22 provide the LED light source 40 with electrical energy. When it is, for example 6:00, the microcontroller 24 will control the electrical energy storing module 22 stop supplying the electrical energy. Because each solar road lamp 10 at the same area or on the same street are equipped with a radio controlled clock 200, and each radio controlled clock 200 obtains time from the same source, these solar road lamps 10 will automatically switch on or off at the same time for many years. In some embodiments, known methods may be employed to adjust the time settings to account for differing times of sunrise and sunset, as well as for daylight savings time.

It is understood that the above-described embodiments are intended to illustrate rather than limit the disclosure. Variations may be made to the embodiments without departing from the spirit of the disclosure. Accordingly, it is appropriate that the appended claims be construed broadly and in a manner consistent with the scope of the disclosure.

What is claimed is:

1. A solar controller comprising
a microcontroller; and
a radio controlled clock configured for receiving a time signal from a radio station and being synchronized to the time signal sent by a radio station, the microcontroller configured to store time-related data provided by the radio controlled clock.

2. The solar controller of claim 1, further comprising an electrical energy storage module for storing electrical energy and powering the radio controlled clock.

3. A solar road lamp comprising:
a solar panel configured to convert sunlight into electrical energy;
a light source; and
a solar controller comprising a microcontroller and a radio controlled clock communicatively coupled to the solar controller for receiving a time signal from a radio station and being synchronized to the time signal, the microcontroller configured to control switching on and off the light source according to the time of the radio controlled clock.

4. The solar road lamp of claim 3, wherein the light source is an LED lamp.

5. The solar road lamp of claim 3, wherein the solar panel is positioned on the top of the light source.

6. The solar road lamp of claim 3, wherein the solar controller further comprises an electrical energy storage module for storing the electrical energy converted by the solar panel.

7. The solar road lamp of claim 6, wherein the electrical energy storage module is configured to power the radio controlled clock.

8. The solar road lamp of claim 3, wherein the microcontroller is configured to store time-related data provided by the radio controlled clock.
